(19) United States
(12) Patent Application Publication
(10) Pub. No.: US 2009/0112724 A1
(43) Pub. Date: Apr. 30, 2009

(54) METHOD AND EQUIPMENT FOR EXPOSING AN ADVERTISEMENT USING APPLICATION

(75) Inventor: Jin Yong Joo, Gyunggi-do (KR)

Correspondence Address: LOWE HAUPTMAN HAM & BERNER, LLP, 1700 DIAGONAL ROAD, SUITE 300, ALEXANDRIA, VA, 22314, US

(73) Assignee: Internet Channel21 Co., Ltd., Seoul (KR)

(21) Appl. No.: 12/301,209

(22) PCT Filed: May 25, 2007
(86) PCT No.: PCT/KR07/02540

§ 371 Date: Nov. 17, 2008

(30) Foreign Application Priority Data
May 26, 2006 (KR) 10-2006-0047645

(51) Int. Cl. G06Q 30/00

(52) U.S. Cl. 705/14

(57) ABSTRACT

The present invention relates to an advertisement display method using an application program and an advertisement management device for performing the advertisement display method. In the advertisement display method of the present invention, whether an application program is running in a terminal is determined. The application program is identified. A location at which an advertisement is to be posted in an execution window output through running of the application program is determined. An advertisement to be arranged at the advertisement posting location of the execution window is searched for. A found advertisement is inserted in the execution window and outputting the execution window.

### TECHNICAL FIELD

The present invention relates to an advertisement display method using an application program and an advertisement management device for performing the advertisement display method.

### BACKGROUND ART

The rapid development of the Internet has caused a considerable increase in the number of Internet users. The Internet space used by such users is attracting advertisers attention as an ideal advertising space capable of replacing existing advertising media. Therefore, Internet advertisement markets have been rapidly developed and settled as main sources for creating profit for portal service providers. The scale thereof has exceeded that of radio and magazines among TV, newspapers, radio and magazines, which are four major advertising media.

Further, companies, which sell office programs, such as Microsoft, etc. on a license basis, are allowing office programs to be operated on the basis of the web, owing to the success of web-based On-Demand software service providers, such as Salesforce.com, and are thus seriously considering whether to distribute such office programs without fee and to utilize advertisements as a source for creating profit.

As described above, advertisements that existed only in web browsers in the prior art are gradually tending to be directly included in various types of application software.

However, advertisers are not seriously considering a method of including advertisements in various types of application software, as well as web browsers. That is, advertisers recognize that it is difficult to obtain great advertising effects from advertisements posted on web sites or application software, in which advertising media are excessively scattered and which are operated on a small scale. For this reason, orders for advertisements have been concentrated only on a small number of large-scale portal sites, and similar and low-class content services have been produced regardless of the classification of portal sites. Moreover, users additionally pay high fees for the information super-highway without being provided with special services or benefits, and thus are greatly dissatisfied.

### DISCLOSURE OF INVENTION

### Technical Problem

Accordingly, an object of the present invention is to provide an advertisement display method and an advertisement management device for performing the advertisement display method, which allow an advertisement control program to be installed in a user PC in order to cause excessively scattered advertisements to be unified on the basis of the user PC, so that, if a previous advertisement is included in a web browser, a sub window, an application program, etc., the previous advertisement may be eliminated and replaced with a newly installed advertisement, or may be overlaid with a newly installed advertisement and, so that, in the case of an empty space having no advertisement, a new advertisement is inserted in the empty space, thus allowing the information super-highway provider or service provider who installed the advertisement control program in the user PC with the agreement of the user to be in sole control of advertisements.

### Advantageous Effects

According to the present invention, a suitable advertisement can be posted in an execution window output when various types of application programs installed in a terminal are run, thus improving advertising effects, and the advertisement to be inserted is received in advance and is downloaded and applied whenever it is necessary, thus maintaining sufficient resources in the terminal and consequently eliminating interference with the smooth running of the application programs.

Further, in the case of sole control of advertisements in a specific user PC, the change of channels is not facilitated, so that exclusive advertising effects are much greater than conventional TV advertisements, and bi-directional communication can be performed to enable customized advertisements, and thus such an advertisement method will be the most preferable advertisement business model for an advertiser. High profit created through this method enables the production and service of high quality content, and enables the provision of free or low cost information super-highway services, as in the case of TV, thus maximizing the satisfaction of users, who are the final consumers.

### BRIEF DESCRIPTION OF THE DRAWINGS

FIG. 1 is a diagram schematically showing the connection of a server and terminals to perform an advertisement display method according to the present invention;

FIG. 2 is a block diagram showing the construction of an advertisement posting management program installed in each terminal to perform an advertisement display method according to the present invention;

FIG. 3 is a flowchart sequentially showing the steps of an advertisement display method according to the present invention;

FIG. 4 is a diagram showing the advertisement display method of the present invention, implemented in a typical plotting program;

FIG. 5 is a diagram showing the advertisement display method of the present invention, implemented in a typical media player; and

FIG. 6 is a diagram showing the advertisement display method of the present invention, implemented in a typical email program.

### BEST MODE FOR CARRYING OUT THE INVENTION

Hereinafter, the present invention will be described in detail with reference to the attached drawings.

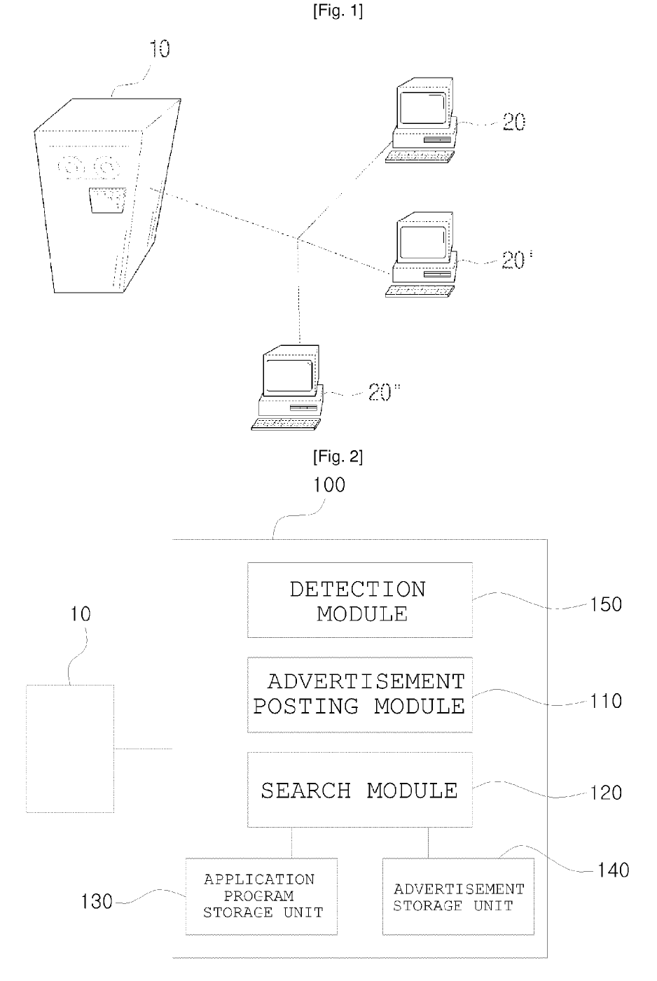

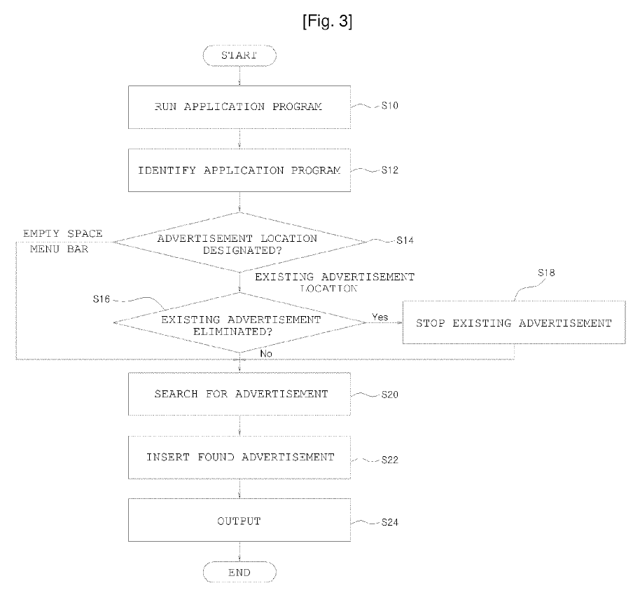

FIG. 1 is a diagram schematically showing the connection of a server and terminals to perform an advertisement display method according to the present invention, FIG. 2 is a block diagram showing the construction of an advertisement posting management program installed in each terminal to perform an advertisement display method according to present invention, and the following description is made with reference to the drawings.

An advertisement display method according to the present invention is adapted to post contracted advertisements in the execution windows of various types of application programs installed in terminals 20, 20 and 20 and to allow users to view the advertisements when the users access the Internet or work offline using their terminals 20, 20, and 20.

Such terminals include all devices in which application programs can be run, such as Internet Protocol TVs (IPTVs) and digital TVs, as well as computers, mobile phones, notebook computers, Digital Multimedia Broadcasting (DMB) phones, and Portable Display Players (PDPs).

In order to perform the advertisement display method, an advertisement management device 100 is installed in each of the terminals 20, 20, and 20. The advertisement management device 100 is a kind of software that users can download and install while accessing the Internet. Of course, when the advertisement management device 100 is installed, an advertisement management server 10 that produced the software manages the advertisement management device.

The advertisement management server 10 distributes a new version of an advertisement management device 100 over the Internet, thus allowing users to download and install the advertisement management device.

The advertisement management device 100 includes an application program storage unit 130 for storing information about an application program that provides a space in which an advertisement can be posted to execution windows in association with the advertisement management device 100, an advertisement storage unit 140 for storing information about advertisements to be posted in the execution windows, a search module 120 for searching the application program storage unit 130 and the advertisement storage unit 140 for required information, an advertisement posting module 110 for posting a found advertisement, and a detection module 150 for determining whether the application program installed in the terminal 20 is running. In this case, the advertisements posted in the execution windows may be initially stored in the advertisement storage unit 140, or may be downloaded in real time from the advertisement management server 10 and may be output when an application program is run.

Therefore, the advertisement management device 100 is executed while communicating with the advertisement management server 10.

Here, the term advertisement means information by which a commodity or service is introduced to consumers, thus arousing their desire to purchase the commodity or service. However, the advertisement in the present invention is not necessarily limited to such information having this purpose, but may include typical information or content having various purposes. Therefore, the term advertisement in the detailed description is selected only for convenience of description, and the technical spirit of the present invention is not restricted to implementations having a simple advertising purpose. The advertisement may be information containing public information, campaign information, information on the search for missing children, news, and other types of information.

FIG. 3 is a flowchart sequentially showing the steps of an advertisement display method according to the present invention. The advertisement display method according to the present invention is described with reference to FIG. 3.

S10: step of running application program

The detection module 150 determines whether the application program installed in the terminal 20 is running.

The running of an application program can be determined through the consumption of system resources such as Basic Input/Output System (BIOS) because the system resources are generally consumed when an application program is running, or can be easily determined through various means.

S12: step of identifying application program

The advertisement management device 100 of the present invention may or may not be operated in association with all of the application programs of the terminal 20 in which the advertisement management device 100 is installed. That is, since the advertisement management device 100 posts an advertisement in the execution window of an application program, it must not only have precise information about the shape of the execution window and the location of an advertisement, but must also have the types and sizes of advertisements applied thereto so that they can be classified according to the application program and can be immediately applied.

Therefore, an operation of determining which application program is currently running is required.

The classification of application programs can be performed in such a way that codes recognizable by the advertisement management device 100 are input as different inherent codes according to the application program and the different codes are transmitted, thus identifying the application program that is currently running.

The detection module 150 determines whether the running application program is registered in the advertisement management device 100 by easily determining the type of application program in addition to determining whether it is running, and determines whether any advertisement associated with the running application program is present if the running application program is determined to be registered.

S14: step of designating advertisement location

If the application program has been identified, the search module 120 searches the application program storage unit 130, thus checking information about the execution window of the given application program. The reason for this is that it is possible to monitor the shape of an execution window that is currently being output, and to post an appropriate advertisement, but it is also possible to execute a promised advertisement and provide the advertisement to the user from the moment that the application program is run, in the case of an application program having an execution window, the shape of which is always uniform.

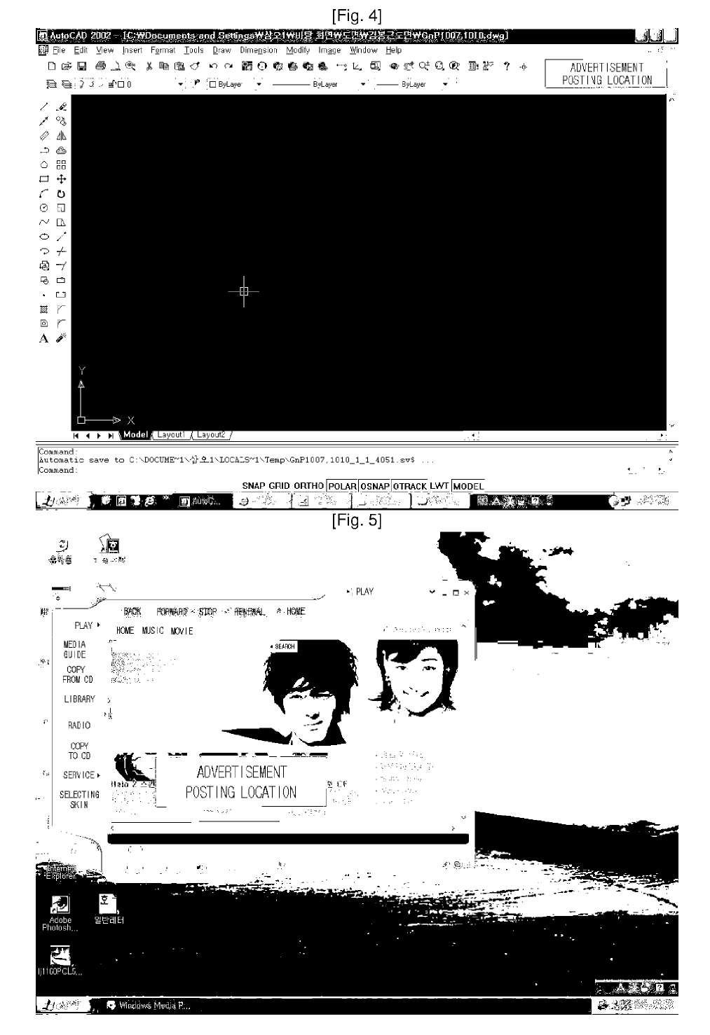

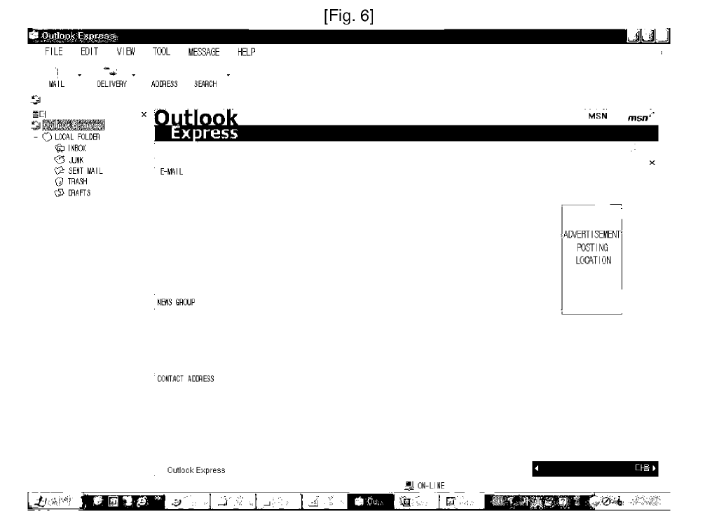

FIG. 4 is a diagram showing the advertisement display method of the present invention implemented in a typical plotting program, FIG. 6 is a diagram showing the advertisement display method of the present invention implemented in a typical email program, and the following description is made with reference to the drawings.

As described above, an application program having an execution window, the shape of which is uniform, may be the plotting program of FIG. 4 or the email program of FIG. 6, and may include various programs such as games, image creation programs, etc.

The application program is implemented so that the shape of the execution window thereof, which appears at startup, is not changed, and the content thereof is not changed either. Accordingly, if the location at which an advertisement is to be posted is designated, an appropriate advertisement can always be posted at that location.

Meanwhile, the advertisement posting module 110 analyzes the execution window of the application program, which is currently running, and thus determines the location at which an advertisement is to be posted and which advertisement is to be posted.

That is, as shown in FIGS. 4 and 6, the advertisement posting location can be selected from among a menu bar, a tool bar, a location bar (hereinafter all referred to as a menu bar), and an empty space. Moreover, as shown in FIG. 5 (showing the advertisement display method of the present invention implemented in a typical media player), at the location at which specific information is displayed, an advertisement can be posted in place of the specific information.

The latter case will be described in detail later.

First, when a menu bar is selected as an advertisement posting location, the size and location of the space occupied by the menu bar are determined. Further, when an empty space is selected as an advertisement posting location, the size and location of the empty space are determined.

S16: step of determining whether existing advertisement has been eliminated

Meanwhile, at the advertisement location designation step S14, when an advertisement to be newly posted according to the advertisement management device 100 of the present invention is posted at the location of an existing advertisement or the location having specific information, a method of limiting the display of the existing advertisement or specific information or overlaying a new advertisement on the existing advertisement or specific information in the form of a layer can be used.

That is, in the former case, in order to actually eliminate the existing advertisement or specific information, which was displayed at an advertisement posting location for a new advertisement within an execution window, as well as to merely hide the existing advertisement or specific information from view, the sources thereof are removed and the source of a new advertisement is input to the existing space which was filled with the removed sources, thus allowing the new advertisement source to replace the source of the existing advertisement or specific information at step S18.

In the latter case, an existing advertisement or specific information, displayed at an advertisement posting location for a new advertisement within an execution window, is merely hidden from view. That is, the new advertisement is overlaid on the advertisement posting location in the form of a layer, thus obtaining the effect of hiding the existing advertisement or specific information.

Generally, it is not very easy to eliminate an existing advertisement or specific information by removing the source thereof. The reason for this is that a typical application program restrictively permits the opening of the source, so that it is difficult to edit the source if it is not open to the public. Therefore, after a new advertisement is created as a separate layer, the created new advertisement is visually overlaid on a boundary desired to be hidden, thus enabling the new advertisement to be promptly output without editing the original execution window.

S20: step of searching for advertisement

The search module 120 searches the advertisement storage unit 140 for an advertisement corresponding to the advertisement posting location. The advertisement storage unit 140 stores therein a plurality of advertisements having various sizes and various types of content as data. The advertisement having a size and content suitable for the determined advertisement posting location within the execution window is selected.

As described above, in the case of an application program having an execution window, the format of which is uniform without change, an advertisement associated with the application program is designated. Accordingly, when the execution window is output while the given application program is run, an advertisement associated with the application program is automatically found, and is thus displayed at the designated advertisement posting location.

S22: step of inserting found advertisement

The advertisement found in the advertisement storage unit S140 is inserted in a corresponding execution window through the advertisement posting module 110. As described above, the insertion of an advertisement is performed using one of two methods. The first method is to eliminate an existing advertisement or specific information hidden by a new advertisement and replace the existing advertisement or specific information with the new advertisement. The second method is to merely overlay the new advertisement on the existing advertisement or specific information and thus hide the existing advertisement or specific information from view.

S24: step of performing output

When the new advertisement is inserted in the advertisement posting location, it is output to allow the user to view it.

In this case, when the advertisement posting location is the menu bar of an execution window, the user must use the menu bar, and thus it is preferable to temporarily eliminate the advertisement when a mouse cursor approaches the menu bar.

For this operation, the advertisement posting module of the advertisement management device 100 checks the location of a mouse cursor and the location of a menu bar in the execution window, thus adjusting the output and elimination of a given advertisement.

When the advertisement needs to be eliminated due to the approach of the mouse cursor, it is possible to fully eliminate the advertisement, but it is also possible to display the portion of the advertisement that does not interfere with the approach of the mouse cursor and to eliminate only the portion over which the mouse cursor is located.

Meanwhile, the output advertisement can be variously represented. That is, one type of advertisement may be continuously output, or different types of advertisements may be regularly or irregularly output to be repeated (rolled) while a given application program is continuously run to output the execution window.

The advertisement management device 100 is adapted to post an advertisement in the execution window of the run application program when the terminal 20 is in an online or offline state. The advertisement stored once in the advertisement storage unit 140 is output while being inserted in the execution window of the application program when the application program promised by the terminal 20 is run.

Therefore, it is preferable that the advertisement management server 10 periodically upgrade the advertisement management device 100 and change the content of the advertisement depending on the contract made with an advertiser. Of course, when the terminal 20 is in an online state, it is possible to directly receive an advertisement from the advertisement management server 10 and to output the advertisement.

A method of replacing a keyword advertisement conducted in typical portal sites is another embodiment different from the advertisement display method of the present invention, and is adapted to replace only an empty space or a keyword advertisement portion with a new keyword advertisement and to maintain the remaining portions without change, in the search result page containing a keyword advertisement.

In detail, an advertisement display method using the replacement of a keyword advertisement includes the steps of a user running a web browser to access a portal site that provides a keyword advertisement; the user entering a keyword in the search box of the portal site and requesting a search; if there is a search request, a separate search request module of a user PC requesting a search from a keyword advertisement server, together with the search request from the web browser; the keyword advertisement server transmitting a new keyword advertisement to the user PC in response to the search request from the separate search request module of the user PC, and allowing the new keyword advertisement to be inserted in an empty space within a search result page or to replace an existing keyword advertisement within the search result page displayed in response to the search request from the web browser, with a new keyword advertisement through a keyword advertisement replacement module, thus displaying the new keyword advertisement.

That is, the above-described method is performed to receive a search request from the user, transmit the search request to the separate keyword advertisement server, and cause the keyword advertisement server to transmit an advertisement matching the keyword to the user PC, so that the transmitted new keyword advertisement is inserted in the empty space in the search result page or is adapted to replace the existing keyword advertisement of a portal site, thus enabling the new keyword advertisement to be displayed.

Meanwhile, methods of replacing the existing keyword advertisement of a portal site include a method of eliminating an existing keyword advertisement and a method of overlaying a layer in which a new keyword advertisement is output on the location at which the existing keyword advertisement was output.

In the above-described embodiment of the advertisement display method according to the present invention, the location at which a keyword is input is not limited to the search box of a portal site, but can also be applied to a Deskbar search box (widget).

For reference, a widget is the collective name of a small Graphical User Interface (GUI) tool used to operate application programs other than an Operating System (OS) in a computer and to display the results of the operation of the application programs on the screen.

In more detail, a widget, which is a small window for receiving information from the Internet and displaying the information on the screen, can provide a plurality of functions, such as a clock, a calendar, a memo pad, search, map, news, and real-time camera, which can be provided by browsers such as Internet Explorer, without opening the browsers. Therefore, the widget is also applied to the search box, thus enabling the user to enter a keyword in a separately displayed search box and to obtain desired search results without accessing a specific portal site.

Next, another embodiment of the advertisement display method according to the present invention may include a method of forcibly obtaining an empty space in a search result page and displaying a new keyword advertisement at the obtained location, at the time of outputting search results based on a keyword search, in addition to the method of inserting a new keyword advertisement in the empty space of the search result page and the method of replacing an existing keyword advertisement with a new keyword advertisement.

This method is described in detail below. An existing keyword advertisement is moved to another location to obtain an empty space, and thus a new keyword advertisement is inserted in the empty space in order to display the new keyword advertisement in an upper portion of a webpage, which can easily attract the user s attention.

A Hyper Text Mark-Up Language (HTML) source is a file basically composed of Text-format tags, and empty space in the HTML source is not actually defined. Therefore, in order to form an empty space in the HTML source of the search result page, the location of a tag is defined in the HTML source of the search result page in advance, and the keyword advertisement replacement module inserts an HTML tag, including a new keyword advertisement, in the predefined tag location through a specific method (web method supporting the function defined on the World Wide Web (WWW): JavaScript, Perl, Net, etc.).

Consequently, the HTML source of the search result page having the HTML tag, including the new keyword advertisement, is executed by the browser, so that the search result page, in which the new keyword advertisement is inserted, is output, and the existing keyword advertisement is arranged at another location.

Since the above operation of inserting the new keyword advertisement in the search result page is adapted to modify (replace/insert) the content (HTML) of data generated in a memory space (memory buffer used in the browser) so as to run the Internet browser, the HTML source stored both in the web server, which transmitted the search result page, and in the user PC, and the HTML source of the search result page, which is output from the user PC and includes the new keyword advertisement, are different from each other.

That is, the HTML source of the search result page, including the new keyword advertisement, is not modified from the HTML source transmitted from the web server. Further, a disposable HTML tag, including the new keyword advertisement, is output, with the disposable HTML tag inserted in the HTML source of the search result page in the memory space. An original HTML source, other than the HTML tag including the new keyword advertisement, is stored in the cache of the Internet.

Meanwhile, the technical spirit of the present invention for editing the HTML source of an existing search result page, artificially obtaining an empty space and subsequently inserting the new keyword advertisement in the empty space is not limited to a keyword advertisement.

That is, when the user PC accesses a specific web server to receive the HTML source of a corresponding webpage and to output the webpage, regardless of a keyword search, an HTML tag including a new advertisement is inserted instead of an existing tag, which is present in the HTML source of the webpage, and the existing tag is edited to be moved to another location. Consequently, all of the information and construction of the original webpage can be maintained without being eliminated, and the new advertisement can be arranged at a desired location in the webpage.

1. An advertisement display method using an application program, comprising the steps of:
determining whether an application program is running in a terminal;
identifying the application program;
determining a location at which an advertisement is to be posted in an execution window output through running of the application program;
searching for an advertisement to be arranged at the advertisement posting location of the execution window; and
inserting a found advertisement in the execution window and outputting the execution window.

2. The advertisement display method according to claim 1, further comprising the step of, if the advertisement posting location is a menu bar, a tool bar, or a location bar, and a mouse cursor is located over at least one selected from among the menu bar, the tool bar, and the location bar while an advertisement is inserted in the execution window, eliminating the advertisement.

3. The advertisement display method according to claim 1, wherein, when the advertisement posting location is a space for providing an existing advertisement or specific information, insertion of the advertisement in the execution window is implemented by replacing a source of the existing advertisement or specific information with a source of a new advertisement.

4. The advertisement display method according to claim 1, wherein, when the advertisement is inserted in the advertisement posting location, the advertisement is overlaid and output on a screen in a form of a layer.

5. An advertisement management device using an application program, comprising:
a detection module for determining whether a running application program is present in a terminal, and identifying a type of application program;
a search module for checking an execution window of the application program, determined by the detection module to determine a location at which an advertisement is to be posted, and searching for an advertisement suitable for the determined location;
an advertisement storage unit including a plurality of advertisements, the advertisement storage unit being searched by the search module;
and an advertisement posting module for inserting an advertisement found by the search module in the execution window of the given application program.

6. The advertisement management device according to claim 5, wherein, when the advertisement posting location is a space for providing an existing advertisement or specific information, the advertisement posting module performs insertion of the advertisement in the execution window by replacing a source of the existing advertisement or specific information with a source of a new advertisement.

7. The advertisement management device according to claim 5, wherein the advertisement storage unit periodically or intermittently updates new advertisements in association with an advertisement management server for providing advertisements.

8. The advertisement management device according to claim 5, further comprising an application program storage unit for checking information about the execution window of the application program, storing associated data, and linking an advertisement associated with the application program to an advertisement stored in the advertisement storage unit.

9. An advertisement display method, comprising the steps of:
entering a keyword in a search box and requesting a search;
if there is a search request, a search request module installed in a user PC requesting a search using the keyword while communicating with a keyword advertisement server, together with the search request from a web browser; and
the keyword advertisement server transmitting a new keyword advertisement to the user PC in response to the search request from the search request module, and a keyword advertisement replacement module performing at least one selected from among a process of displaying a new keyword advertisement by inserting the new keyword advertisement in an empty space of a search result page obtained in response to the search request from the web browser, a process of displaying a new keyword advertisement by replacing an existing keyword advertisement of a search result page with the new keyword advertisement, and a process of displaying a new keyword advertisement by inserting a tag of the new keyword advertisement, instead of an existing tag, in a Hyper Text Mark- Up Language (HTML) source, constituting a search result page, and by editing the existing tag to move it to another location.

10. An advertisement display method, comprising the steps of:
a user PC accessing a web server and receiving a Hyper Text Mark-Up Language (HTML) source constituting a webpage from the web server;
the user PC receiving a new advertisement from an advertisement server; and
inserting a tag of a new advertisement, instead of an existing tag, in the HTML source constituting the web page, and editing the existing tag to move it to another location, thus displaying the new advertisement.

11. The advertisement display method according to claim 2, wherein, when the advertisement posting location is a space for providing an existing advertisement or specific information, insertion of the advertisement in the execution window is implemented by replacing a source of the existing advertisement or specific information with a source of a new advertisement.

12. The advertisement display method according to claim 2, wherein, when the advertisement is inserted in the advertisement posting location, the advertisement is overlaid and output on a screen in a form of a layer.

13. The advertisement management device according to claim 6, further comprising an application program storage unit for checking information about the execution window of the application program, storing associated data, and linking an advertisement associated with the application program to an advertisement stored in the advertisement storage unit.

14. The advertisement management device according to claim 7, further comprising an application program storage unit for checking information about the execution window of the application program, storing associated data, and linking an advertisement associated with the application program to an advertisement stored in the advertisement storage unit.
